(19) United States
(12) Patent Application Publication
(10) Pub. No.: US 2023/0154689 A1
(43) Pub. Date: May 18, 2023

(54) SOLID ELECTROLYTE CAPACITOR AND METHOD FOR MANUFACTURING SAME

(71) Applicant: NIPPON CHEMI-CON CORPORATION, Tokyo (JP)

(72) Inventors: Kenta Sato, Tokyo (JP); Yusaku Ito, Tokyo (JP); Mizuki Okamoto, Tokyo (JP); Hirotugu Ashino, Tokyo (JP)

(73) Assignee: NIPPON CHEMI-CON CORPORATION, Tokyo (JP)

(21) Appl. No.: 17/916,361

(22) PCT Filed: Mar. 29, 2021
(86) PCT No.: PCT/JP2021/013430

§ 371 Date: Sep. 30, 2022

(30) Foreign Application Priority Data
Mar. 31, 2020 (JP) 2020063757

(51) Int. Cl. H01G 9/15; H01G 9/028; H01G 9/012; H01G 9/00

(52) U.S. Cl. CPC H01G 9/15; H01G 9/012; H01G 9/028; H01G 9/0036

(57) ABSTRACT

A solid electrolytic capacitor with reduced leakage current is provided. An anode foil dielectric oxide film is formed, a lead terminal which is connected to the anode foil, a capacitor element including the anode foil, is formed in the capacitor element, and a solid electrolyte containing a conductive polymer, and a coating layer for elasticating a conductive polymer forming solution between the anode foil and the lead terminal by forming a solid electrolytic capacitor. Preferably, the coating layer is a solid-state electrolytic capacitor formed at least in the opposite portion of the external leading terminals to the anodal foil.

### TECHNICAL FIELDS

The present invention relates to a wound solid electrolytic capacitor having a solid electrolyte containing a conductive polymer and a method for manufacturing the same.

### BACKGROUND TECHNIQUES

Electrolytic capacitor utilizing a valve action metal such as tantalum or alum inum, by widening the valve action metal as the anode-side electrode in the shape of a si ntered body or etching foil or the like, it is possible to obtain a large capacity in a small size. In particular, the solid electrolytic capacitor is small, large capacity, low equivalent series resistance, in addition to having such characteristics as easy chipping and suitabl e for surface mounting, it is indispensable for miniaturization, function enhancement, an d cost reduction of electronic equipment.

As a solid electrolyte, manganese dioxide or a 7,7,8,8-tetracyanoquinodimet hane (TCNQ) complex is known. Recently, a conductive polymer derived from a mono mer having a π-conjugated double bond, such as poly(3,4-ethylenedioxythiophene) (PE DOT), which is excellent in adhesion to a dielectric oxide film formed on a surface of a n anodic foil, has rapidly become popular as a solid electrolyte. In the conductive polym er, a polyanion such as an organic sulfonic acid is used as a dopant during chemical oxi dative polymerization or electrolytic oxidative polymerization, and high conductivity is exhibited.

In addition, a so-called hybrid type of solid electrolyte capacitor has been pr oposed in which an electrolyte layer is formed in a capacitor element opposed to an ano dal foil and a cathodal foil, and electrolyte is impregnated in the pore of the capacitor el ement (see, for example, Patent 1). The solid electrolyte capacitor with this electrolyte a lso provides the electrolyte solution to repair the defective part of the dielectric oxide ca psule and reduces the leakage current of the solid electrolyte capacitor.

### PRIOR ART DOCUMENTS

### Patent Literature

Patent literature 1: JP 2006-114540

### SUMMARY OF THE INVENTION

### Problem to Be Solved by the Invention

Subsequently, solid electrolyte capacitors with only solid electrolyte layers a nd solid electrolyte layers combined with electrolyte fluids are simply referred to as soli d electrolyte capacitors. As the structure of the solid electrolytic capacitor, generally, an anode foil formed with a dielectric oxide film on the surface of the expanded aluminum foil, and the cathode foil as an electrolyte in the capacitor element formed by winding th rough a separator solid electrolyte layer or, there are those comprising a solid electrolyte layer and the electrolyte. In the field of such solid electrolytic capacitors, further reducti on of the leakage current caused by the defect portion of the dielectric oxide film is alwa ys required. However, remediation of defective parts by electrolytic solution cannot be e xpected in solid electrolytic capacitors only with solid electrolytes. And, even if the soli d electrolyte capacitor combined with the electrolyte solution is used, the repair of the d efective part can not be expected, when the position of the defective part is not filled wit h the electrolyte solution.

The invention has been proposed to solve the above problems, the purpose o f which is to provide a solid electrolytic capacitor with reduced leakage currents and a method for its production.

### Means for Solving the Problem

The present inventors have, in the case of a solid electrolytic capacitor woun d, the lead terminal of the anode side during winding has caused a defect portion in the dielectric oxide film. Defective portion by the lead-out terminal, as compared with the d amaged portion caused by the bending stress applied to the entire anode foil during win ding, even in the repair step of the dielectric oxide film of the manufacturing process of the solid electrolytic capacitor it may be difficult to be completely repaired. Further, wh en placing the solid electrolytic capacitor on a wiring board such as a circuit board, the s tress is applied to the extraction terminal, by the stress is transmitted to the contact porti on between the extraction terminal and the anode foil, the dielectric oxide film of the an ode foil surface is damaged there is a case where the defect portion is formed. The diele ctric oxide film is also formed on the surface of the extraction terminal of the anode sid e. Dielectric oxide film of the lead-out terminal surface, before connecting the lead term inal to the anode foil, or is formed by forming a surface of the lead-out terminal by previ ously immersed in the chemical conversion solution, a capacitor element produced by w inding an anode foil connecting the lead terminal when the repair conversion surface of the lead terminal is formed in some cases. There is a case where a defect portion also oc curs in the dielectric oxide film formed on the extraction terminal. It was found that the defect portion generated in the dielectric oxide film formed on such anode foil and the 1 ead-out terminal contributed to an increase in the leakage current of the solid electrolyti c capacitor. Further, as a result of the sharp research, it was proven that this increase of 1 eakage current occurred when conductive polymer existed near the defect, and there wa s little or no electrolyte in the vicinity of the defect. In other words, it was proven that th e leakage current could be suppressed, if the conductive polymer was absent near the de feet. Even when a solid electrolytic capacitor is used with an electrolyte solution, the ele ctrolyte is impregnated after the conductive polymer is impregnated into the capacitor el ement. This leads to leakage currents when the conductive polymer is present in the def ect where the external leading terminal is created, because the conductive polymer is blo cked in the air space between the external leading terminal and the electrode foil, and th e electrolyte is difficult to stain.

The present invention has been made on the basis of this finding, an anode f oil dielectric oxide film is formed, a lead terminal connected to the anode foil, a capacit or element including the anode foil, formed in the capacitor element, a solid electrolyte containing a conductive polymer, the anode foil and forming a coating layer that elastica tes a conductive polymer forming solution between the lead terminal, characterized in th at.

The formation of a coating layer elastic of conductive polymer forming solu tion between the anodal foil and an external leading terminal inhibits the entry of condu ctive polymer forming solution between the anodal foil and the external leading termina 1. Therefore, it is possible to suppress the adhesion of the conductive polymer to the vici nity of the defect portion caused by the lead terminal between the anode foil and the lea d terminal, the leakage current is suppressed. Further, when the defective portion is pres ent in the dielectric oxide film on the surface of the lead-out terminal, it is possible to su ppress the adhesion of the conductive polymer to the vicinity of the defective portion, th e effect of leakage current is suppressed can also be expected. The coating layer may for m at least in the opposite part of the external leading terminal to said anodal foil.

The coating layer may be formed on the lead terminal lead-out end face side of the capacitor element from the connection portion between the anode foil of at least t he lead-out terminal.

The thickness of the coating layer may be more than 10 nm.

The contact angle between the surface of the coating layer and the conductiv e polymer forming solution may be 80 ° or more.

The thickness of the coating layer may be at least 10 nm and not more than 8 0nm.

The coating layer may be incompatible with the solution immersed in the re storation process of the capacitor element.

The method of manufacturing a solid electrolytic capacitor, after connecting the lead terminal to the anode foil cathode foil and the dielectric oxide film is formed, winding the cathode foil and the anode foil while winding the lead terminal, a winding s tep of forming a capacitor element, After the winding step, formed around the lead termi nal, the lead terminal is connected to the anode side foil and an electrolyte forming step of immersing a solution to form a solid electrolyte from the opposite surface of the end f ace of the capacitor element to be derived, at least the anode side of the lead terminal ch aracterized in that to form a coating layer that elasticates the conductive polymer formin g solution.

When a capacitor element is soaked in a conductive polymer forming soluti on, it is inhibited that the solution enters the void by forming a coating layer elastic to di sperse liquid near the void, and the solution does not reach the defect of the dielectric ox ide coat formed on the surface of the anodal foil produced by the external leading termi nal. Therefore, the conductive polymer is absent in the vicinity of the defect portion in t he gap portion, the leakage current is suppressed. Further, when the defective portion is present in the dielectric oxide film on the surface of the lead-out terminal, it is possible t o suppress the adhesion of the conductive polymer to the vicinity of the defective portio n, the effect of leakage current is suppressed can also be expected.

### Effects of Invention

According to the invention, leakage currents can be suppressed because the probability of the presence of conductive polymers near the defect created by the extern al leading terminals is reduced.

### BRIEF DESCRIPTION OF THE DRAWINGS

FIG. 1 Illustration showing an example of a capacitor device prior to case storage related to this Embodiment.

FIG. 2 It is a cross-sectional view through an imaginary line connecting th e lead terminal of the anode side of the capacitor device and the lead terminal of the cat hode side according to the present Embodiment.

FIG. 3A Illustration showing the cross-section of the hypothetical lines a-a in FIG. 2.

FIG. 3B Illustrations showing cross sections of virtual lines b-b.

FIG. 4 This Embodiment is a close-up view of the connection between the anodal foil and an anodal external leading terminal.

FIG. 5 Is a diagram showing a state of expanding the capacitor device acc ording to the present Embodiment.

FIG. 6A Illustration showing the connection between the external leading terminals and the electrode foil in accordance with this Embodiment.

FIG. 6B Illustration showing the connection between the external leading t erminals and the electrode foil in accordance with this Embodiment.

FIG. 6C1 Illustration showing the connection between the external leading terminals and the electrode foil in accordance with this Embodiment.

FIG. 6C2 Illustration showing the connection between the external leading terminals and the electrode foil in accordance with this Embodiment.

FIG. 6D Illustration showing the connection between the external leading terminals and the electrode foil in accordance with this Embodiment.

FIG. 7 A schematic diagram shows the impregnation of the conductive pol ymer dispersion into a capacitor element.

FIG. 8A Is a diagram showing the formation position of the coating layer of Example 1.

FIG. 8B Is a diagram showing the formation position of the coating layer of Example 1.

FIG. 9A Is a diagram showing the formation position of the coating layer of Example 2.

FIG. 9B Is a diagram showing the formation position of the coating layer of Example 2.

### DETAILED DESCRIPTION

The solid-state electrolytic capacitor in accordance with Embodiment of the invention will be described below. In this Embodiment, we illustrate and illustrate a soli d-state electrolyte capacitor that combines electrolytes. The present invention is not limi ted to Embodiment described below.

### First Embodiment

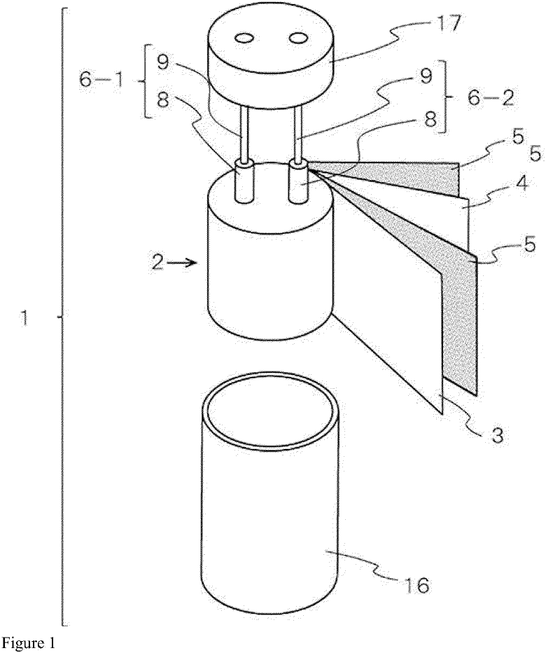

Referring to FIG. 1 to FIG. 5, the first Embodiment solid-state electrolyte cap acitor is described. FIG. 1 shows an example of a capacitor element prior to the first E mbodiment case. The first Embodiment solid-state electrolytic capacitor 1 is a passive el ement that performs charge storage and discharge by capacitance. This solid-state electr olytic capacitor 1 has, for example, a coiling-type capacitor element 2. Capacitor eleme nt 2, the anode foil 3 dielectric oxide film is formed on the surface, and the cathode foil 4 is opposed via a separator 5, the solid electrolyte is formed. Solid electrolytes adhere c losely to dielectric oxide capsules formed in anodal foil 3 and function as true cathodes. This solid electrolytic capacitor 1 may be filled with an electrolytic solution in addition to a solid electrolyte.

Anodic material 3 is a long foil made of valvular metals. Valve action metal s include aluminum, tantalum, niobium, niobium oxide, titanium, hafnium, zirconium, z inc, tungsten, bismuth and antimony. The purity is preferably about 99.9% or more, but impurities such as silicon, iron, copper, magnesium, and zinc may be contained. The an ode foil 3 forms a plane expanding layer on the stretched foil, formed by forming a diele ctric oxide film on the surface of the expanding layer. The plane expanding layer is for med by cancellous pits and tunnel-shaped pits dug in the thickness direction from the fo il surface. Or, the expanding layer is formed by sintering the powder of the valve action metal, or may be formed by depositing a film such as metal particles on the foil.

The surface of the enlarged surface layer dielectric oxide film layer is forme d. The dielectric oxide capsule layer is an aluminum oxide layer that oxidizes the porous structure region, for example, if the anodal foil 3 is made of aluminum. The dielectric o xide coating is formed by a chemical conversion treatment of applying a voltage in a sol ution without halogen ions such as ammonium borate, ammonium phosphate, an acid su ch as ammonium adipate or an aqueous solution of these acids.

Cathode foil 4 is a metal foil such as aluminum similarly to the anode foil 3, using those only etching treatment is applied to the surface.

The anode foil 3 and the cathode foil 4 lead terminal 6-1 of the anode side f or connecting the respective electrodes to the outside, the lead terminal 6-2 of the catho de side, stitches, are connected by ultrasonic welding or the like. Through the lead termi nals 6-1, 6-2, the solid electrolytic capacitor 1 is mounted to an electrical circuit or an el ectronic circuit. Lead terminals 6-1 and 6-2, for example, an aluminum wire and a metal wire 9. Aluminum wire includes a flat plate portion 7 formed by crushing one end side of the round bar shape by press working or the like, a round bar portion 8 of the unpress ed on the other end side. The tip portion and the metal wire 9 of the round bar portion 8 is connected by arc welding or the like. Extraction terminal 6-1 of the anode side, by ch emical conversion treatment on the surface of the flat plate portion 7 may form a dielect ric oxide film.

The flat plate portion 7 of the lead terminal 6-1 is brought into contact with one surface of the anode foil 3, the round bar portion 8 and the metal wire 9 is protruded from the anode foil 3 so as to be perpendicular to the long side of the anode foil 3, conn ecting the lead terminal 6-1 and the anode foil 3. Leading terminal 6-2 and the cathode f oil 4 is also connected similarly to the anode side. Connections may be made using one of a variety of connecting means, such as stitching, cold welding, ultrasonic welding or laser welding.

Anode foil 3 lead terminal 6-1 is connected, the cathode foil 4 lead terminal 6-2 is connected, wound superimposed via a separator 5. Examples of the separator 5 in clude cellulose such as kraft, manila hemp, hept, and rayon, and poly esters based resins such as polyethylene terephthalate, polyethylene naphthalate, and derivatives thereof, p olytetrafluoroethylene-based resins, polyvinylidene fluoride-based resins, aliphatics pol y amides, semi aromatics poly amides, polyimide-based resins, polyethylene resins, pol ypropylene resins, triphenylene sulfide resins, acrylic resins, and polyvinyl alcohol resin s These resins may be used alone or in combination.

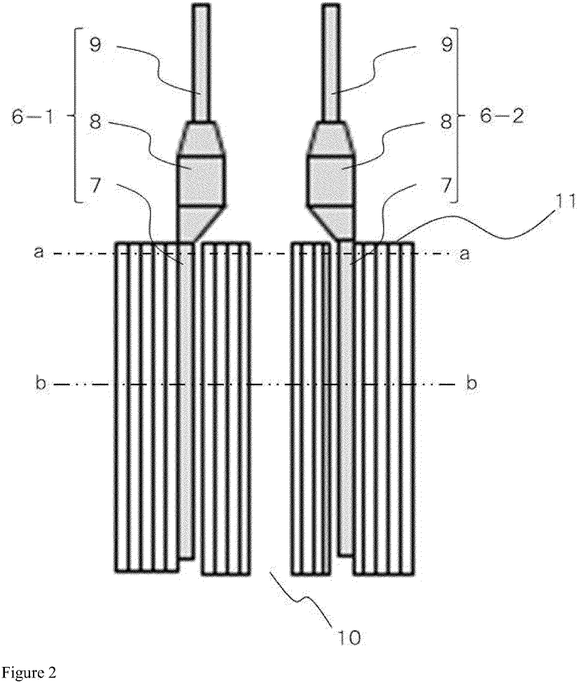

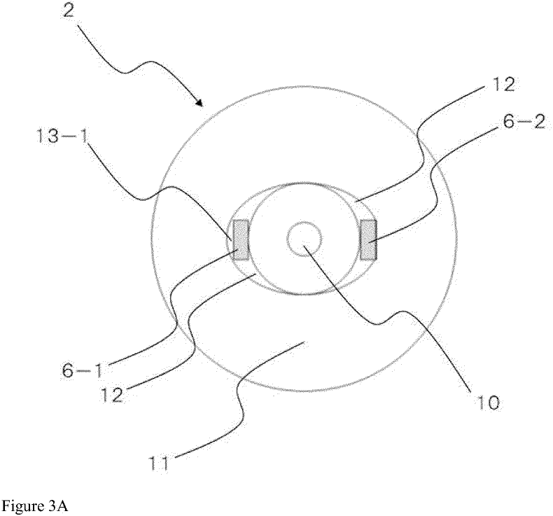

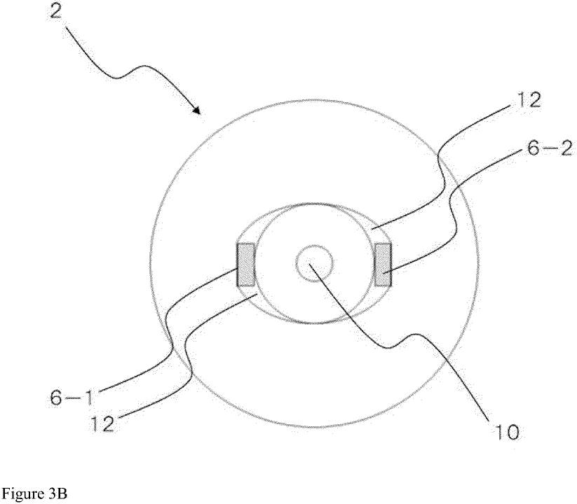

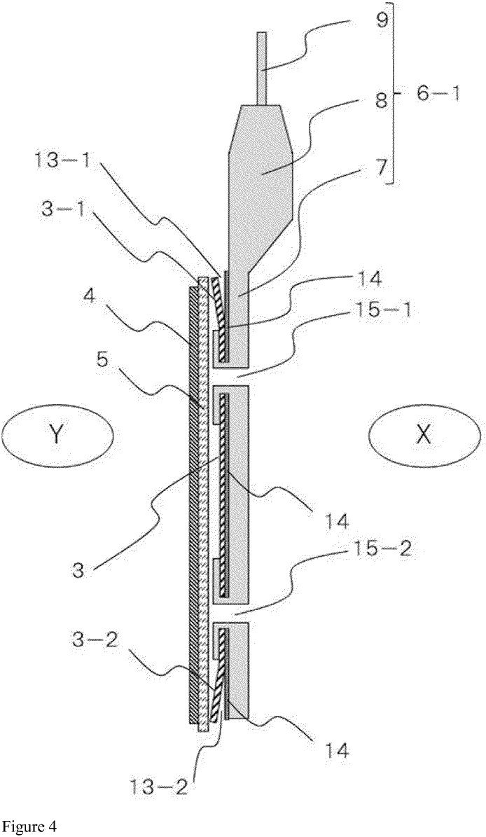

FIG. 2 is a cross-sectional view through an imaginary line connecting the anode-side lead terminal 6-1 and the cathode-side lead terminal 6-2 of the capacitor ele ment 1. FIG. 3A is a view showing the cross-section of the hypothetical lines a-a in Fi gure 2, and the FIG. 3B is a view showing the cross-section of the hypothetical lines b-b in FIG. 2. FIG. 4 is an enlarged view of the connection portion of the anode foil 3 and the lead terminal 6-1 of FIG. 4, the right side of the drawing the inner peripheral sid e of the capacitor element 2 (center side) X, the left side of the drawing shows the outer peripheral side Y of the capacitor element 2. FIG. 5 is a diagram showing a state of de veloping the capacitor element 2 of FIG. 5, the lower side of the drawing the inner perip heral side of the capacitor element 2 (center side) X, the upper side of the drawing show s the outer peripheral side Y of the capacitor element 2. Anode foil 3, the lead terminal 6-1 is connected to the surface of the inner peripheral side X of the capacitor element 2, the cathode foil 4, the lead terminal 6-2 is connected to the surface of the outer peripher al side Y of the capacitor element 2.

As shown in FIGS. 1 to 3, the capacitor element 2 has a shape of a wound b ody. Central portion of the capacitor element 2, because it is withdrawn after winding th e winding shaft used during winding, and a hole portion 10 penetrating from one end fa ce of the capacitor element 2 to the other end face. Leading terminals 6-1, 6-2 are entan gled by winding process, the lead terminal 6-1 is one end face of the capacitor element 2, and is derived from the lead terminal lead-out end face 11 of 6-2. Further, the lead ter minals 6-1 and 6-2, the winding layer to which the lead terminal is connected, is sandwi ched between the winding layer of the one inner periphery thereof. The pinching of the lead terminal 6-1, 6-2, the width direction of the lead terminal 6-1, 6-2, in other words, a round both ends in the circumferential direction of the capacitor element 2, crescent-sha ped hole portion 12 is generated. Crescent-shaped hole 12, along the axis of the capacito r element 2 extends through the capacitor element 2 has an opening on both end faces of the lead terminal deriving end face 11 and the opposite end face of the capacitor elemen t 2.

Gaps 13-1, 13-2 are generated between the extraction terminal 6-1 of the an ode foil 3. The gap 13-1, 13-2 is caused by the structure of the connecting method and t he capacitor element 2 between the anode foil 3 and the lead terminal 6-1. As a result of the structure of the capacitor element 2, the lead terminal 6-1 of the anode side with res pect to the anode foil 3, it may be disposed on the center side of the capacitor element 2. As shown in FIG. 4, the length direction of the opposing portion of the lead terminal 6-1 of the anode foil 3, in other words, the end portion 3-1 in the direction perpendicular to the circumferential direction of the capacitor element 2 is slightly along the outer peripheral side Y. Since the dielectric oxide film formed on the surface of the anode foil 3 is hard and brittle, the anode foil 3 is harder than the cathode foil 4, acts on the outer perip heral side of the capacitor element 2 by its restoring force even when wound. Therefore, the connection portion between the anode foil 3 maintains a state in contact with the lea d terminal 6-1, the end portion 3-1 near away from the connection portion between the lead terminal 6-1 is slightly warped on the outer peripheral side Y, the anode foil 3 and the lead terminal 6-1 gap portion 13-1, 13-2 occurs between. Such a phenomenon, with r espect to the anode side of the lead terminal 6-1 is the anode foil 3, but appears remarka bly when connected to the center side X of the capacitor element 2 is not limited theret o. With respect to the anode side of the lead terminal 6-1 is the anode foil 3, in the case of being connected to the outer peripheral side Y of the capacitor element 2, since the ca pacitor element 2 is wound structure, the anode foil 3 is curved around the connecting p ortion between the lead terminal 6-1, the width direction of the lead terminal 6-1, in oth er words the end portion and the anode foil 3 in the circumferential direction of the capa citor element 2 is spaced apart, there is a case where the gap portion 13-1, 13-2 occurs, t he same problem is considered to occur.

As due to the connection method between the anode foil 3 and the lead term inal 6-1, the stress applied to the anode foil 3 during connection. The connection, for ex ample, by penetrating the cut and raised piece 23 generated in the lead terminal 6-1 by i nserting the stitch needle to the flat plate portion 7 of the lead terminal 6-1 superimpose d on the anode foil 3 to the anode foil 3, cut and raised piece 23 by pressure molding, it is connected by sandwiching the anode foil 3 between the flat plate portion 7 and the cut and raised piece 23. Thus, the connection between the lead terminal 6-1 and the anode f oil 3 is performed.

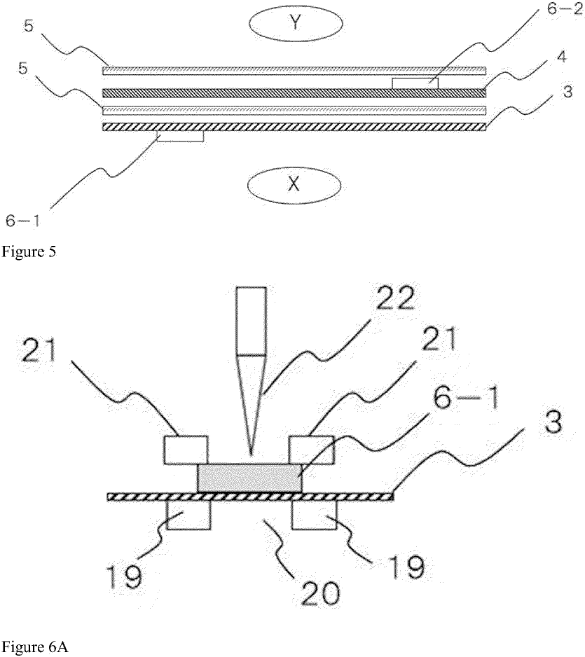

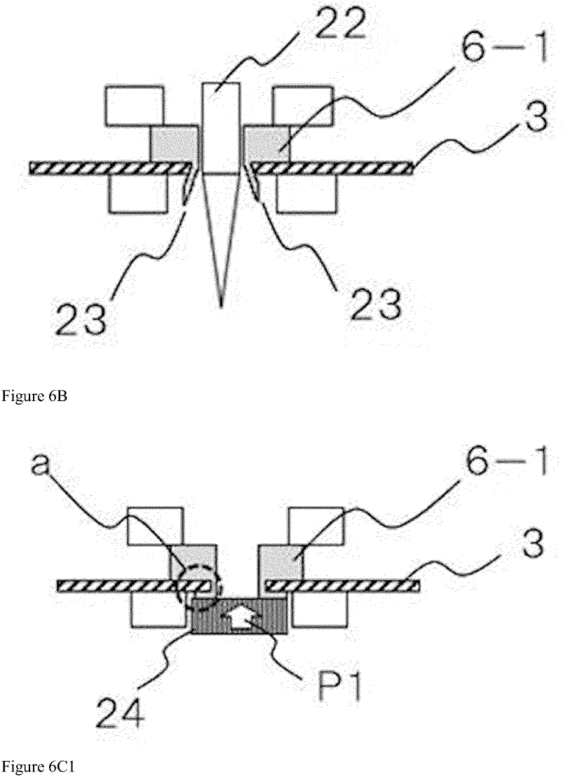

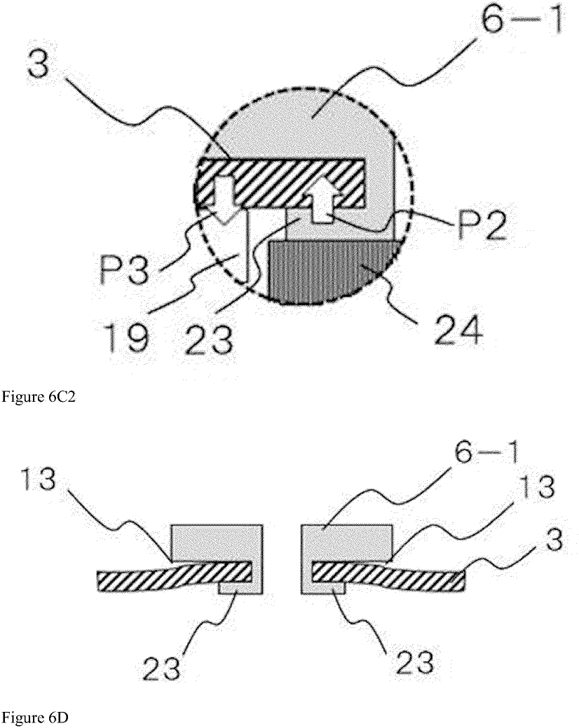

Connecting, as shown in FIG. 6A, placing the anode foil 3 on the lower mol d 19, placing the flat plate portion 7 of the lead-out terminal 6-1 at a position for closing the hole portion 20 of the lower mold 19, sandwiched by the upper mold 21.

Next, as shown in FIG. 6B, the stitching needle 22 is lowered from the drawi ng terminal 6-1 side. When penetrating the stitch needle 22 from the extraction terminal 6-1 side to the anode foil 3, cut and raised piece 23 generated in the extraction terminal 6-1 penetrates the anode foil 3 together with the stitch needle 22.

Next, as shown in FIG. 6C1, the stitch needle 22 is elevated, and then the mo ld 24, which was waiting for the translucent hole 20 of the inferior type 19, is elevated. The rise of the mold 24, and molded by pressing the cut and raised piece 23 between the mold 24 and the upper mold 21, to connect the cut and raised piece 23 to the back side of the anode foil 3. Thus, the anode foil 3 is sandwiched between the extraction terminal 6-1 and the cut-and-raised piece 23 is electrically connected to the extraction terminal 6 -1. In the connection of such a stitching, as shown in 6C2 (broken line portion a in the d rawing 6C1), when pressing the cut and raised piece 23, the stress P1 applied from the mold 24 is transmitted as a stress P2 around the connecting portion between the lead ter minal 6-1 of the anode foil 3 via the cut and raised piece 23. On the surface of the anode foil 3, since the hard and brittle dielectric oxide film is formed, the anode foil 3 has low flexibility. Therefore, when the stress P2 is applied, the reaction, at a portion away fro m the connecting portion, the stress P3 in the direction away from the lead terminal 6-1 occurs. In this state, as shown in 6D when separating the lower mold 19 and the upper mold 21 from the anode foil 3, the width direction of the end portion of the anode foil 3 and the lead terminal 6-1, in other words the gap 13-1, 13-2 occurs between the circumf erential end of the capacitor 2.

As a method of connecting the anode foil 3 and the extraction terminal 6-1, t he stitch method, not limited to this, the same applies to the cold welding method and th e ultrasonic welding method. Cold welding, placing the anode foil 3 to the flat plate port ion 7 of the lead terminal 6-1, by pressing the layer stack portion of the flat plate portion 7 from the anode foil 3 side in a cold welding mold, connecting the lead terminal 6-1 an d the flat plate portion 7. Ultrasonic welding method, placing the anode foil 3 to the flat plate portion 7 of the lead terminal 6-1, by applying a pressing and ultrasonic vibration 1 aminated portion between the flat plate portion 7 from the anode foil 3 side, the lead ter minal 6-1 and the flat plate portion 7 connecting. Cold welding method, in any case of u ltrasonic welding method, there is a step of pressing the lead terminal 6-1 from the anod e foil 3 side. Therefore, similarly to the stitching method, the pressing portion, the anod e foil 3 is pressed to the lead terminal 6-1 side, although the lead terminal 6-1 and the an ode foil 3 is in close contact, the portion away from the pressing portion, the reaction of the pressing, the anode foil 3 is stressed in a direction away from the lead terminal 6-1. Therefore, even in the cold welding method and the ultrasonic welding method, the end portion in the width direction of the anode foil 3 and the lead terminal 6-1, in other wor ds, between the end portion in the circumferential direction of the capacitor element 2, t he gap 13-1, there is a possibility that 13-2 occurs.

The coating layer 14 is formed between the anode foil 3 and the extraction t erminal 6-1. The coating layer 14 is formed of, for example, a silicone-based resin or a c oating agent made of a fluorine based resin. The coating layer 14 may be formed betwee n the anode foil 3 and the extraction terminal 6-1. In the first Embodiment, it is formed by applying a coating agent to the area contacting anodal foil 3 of the drawer terminals 6-1. In the case of forming the coating layer 14 to the draw terminal 6-1, among the port ion in contact with the positive foil 3 of at least the draw terminal 6-1 of the flat panel 7, if it is formed in a face-to-face portion of the draw terminal end 11 from the connection portion 15-1 with the positive foil 3 close to the metal wire 9, may be formed in a porti on in contact with the positive foil 3 of the flat panel 7 of the draw terminal 6-1, may be formed in the whole draw terminal 6-1. It is sufficient for the coating layer 14 to be able to resilient the solvent of the solution so that the conductive polymer forming solution d oes not enter into the aforementioned void portion 13-1

The thickness of coating layer 14 tends to have a smaller leakage current wh en it is over 1.5 nm. The thickness of coating layer 14 is preferably more than 10 nm. Mo reover, considering the connectivity with the drawer terminals 6-1, the following 80 nm i s preferred: Therefore, more preferably 10 nm or more and 80 nm or less. The thickness o f the coating layer 14 can be appropriately adjusted by adjusting the concentration of the main agent relative to the solvent. For example, in the present Embodiment, it is prefer able to set 0.1 wt% to 2.0 wt%

Further, it is preferable that the contact angle between the surface of the coat ing layer 14 and the conductive polymer forming solution is 80 ° or more. In this way, l eakage currents tend to be smaller.

Coating layer 14 has, for example, a surface resistance of 1×10⁵ Ω • cm² or more.

Further, the coating layer 14, in the case of connecting the anode foil 3 and t he lead-out terminal 6-1 by a stitch connection method, the stress applied to the lead-out terminal 6-1 when forming the cut-and-raised piece 23 by piercing the stitch needle, or cracks in the coating layer 14 or it is preferable not to peel off. On the other hand, it is m olded by pressing the cut and raised piece 23 in the molding die 24, when connecting th e cut and raised piece 23 to the rear surface side of the anode foil 3, the coating layer 14 of the portion in contact with the anode foil 3 of the cut and raised piece 23 is cracked it is sufficient strength to occur. For example, when a stitch needle is pierced to form a cut -and-raised piece 23, it is believed that a 10Mpa degree of loading is applied to the surfa ce of the lead-out terminal 6-1. Therefore, it is preferable that at least coating layer 14 h as strength that does not result in tears or detach, even when 10Mpa loading is applied. Further, or cracks in the coating layer 14, because it does not peel off, contact between t he ground of the conductive polymer and the anode foil 3 and the lead-out terminal 6-1 i s suppressed, it is considered that the leakage current is reduced. On the other hand, by pressing the cut and raised piece 23 in the molding die 24, when connecting the cut and raised piece 23 to the back side of the anode foil 3, the cut and raised piece 23, stresses of the degree of 50Mpa is applied. At this time, although cut and raised piece 23 is stret ched by stress, also extends so as to follow the surface of the cut and raised piece 23, or the coating layer 14 is thin, or cracks in the coating layer 14 formed on the surface occur s, the ground portion of the cut and raised piece 23 is exposed. Since the coating layer 1 4 is provided with an insulating property, by the coating layer 14 is in contact with the e xposed portion and the anode foil 3 of the thin portion and the ground metal, the electric al connectivity is improved.

After turning anodal foil 3, cathodal foil 4, and separator 5, solid electrolyte s are formed in the capacitor element 2. The solid electrolyte includes a conductive poly mer. The conductive polymer is a doped conjugated polymer. The conjugated polymer i s obtained by chemical oxidative polymerization or electrolytic oxidative polymerizatio n of a monomer having a π-conjugated double bond or a derivative thereof.

This solid electrolyte is interposed between anodal foil 3 and cathodal foil 4 to adhere closely with the dielectric oxide capsule. However, as discussed below, solid e lectrolytes are less in the periphery of the coating layer 14 compared with the other parts of the capacitor element 2 by preventing the attachment of conductive polymer forming solutions by this coating layer 14.

Capacitor element 2 solid electrolyte is formed, not shown, is housed in the bottomed cylindrical outer case 16 made of aluminum or the like, the opening or an elas tic body, by caulking by the sealing member 17 made of a composite member between t he elastic body and the hard body, sealed, the solid electrolytic capacitor 1 is formed.

### Second Embodiment

In the first Embodiment, coating layer 14 was formed at the drawer terminal s 6-1, whereas in the second Embodiment, coating layer 14 was formed at the surface w here the drawer terminals 6-1 of anodal foil 3 are connected. Additional configurations a re the same as in the first Embodiment and their explanations are omitted.

### Manufacturing Method

An example of the manufacturing method for this solid-state electrolytic cap acitor 1 is shown. First, a coating layer formation step that forms a coating layer 14 at th e drawer terminals 6-1 is performed. Next, the anode foil 3 connecting the lead terminal 6-1 to form a coating layer 14, wound by interposing a separator 5 between the cathode foil 4 connected to the lead terminal 6-2, the winding step of producing a capacitor elem ent 2. Next, the restoration process is carried out by immersing the capacitor element 2 i n a liquor to repair the dielectric oxide capsule. Note that, in the restorative chemical co nversion step, a step of removing the chemical conversion liquid by a chemical conversi on liquid cleaning liquid such as pure water is included in order to remove the chemical conversion liquid from the capacitor element 2 after the restorative chemical conversio n.

Next, an electrolyte forming step is performed in which a dispersion of a co nductive polymer is impregnated into the capacitor element 2 to form a solid electrolyte after passing through a drying step of removing the chemical conversion liquid or the ch emical conversion liquid cleaning liquid. When an electrolytic solution is used in combi nation, an electrolytic solution impregnation step of further impregnating the capacitor e lement 2 with an electrolytic solution is performed.

In the coating layer formation step, a coating layer 14 is formed that elastize s the conductive polymer formation solution described below between the anodal foil 3 and the drawer terminals 6-1. Formation point of the coating layer 14 may be between t he anode foil 3 and the lead terminal 6-1 may be formed on the surface or the surface of the anode foil 3 of the lead terminal 6-1. When the coating layer 14 is formed on the lea d terminal 6-1, it may be formed on the surface of the flat plate portion 7 between the co nnecting portion 15-1 and the round bar portion 8 close to the metal wire 3 of the conne cting portion 15 with the anode foil 3 of the lead terminal 6-1 in the portion in contact w ith the anode foil 3 of the lead terminal 6-1, and may be formed on the entire surface of t he flat plate portion 7 opposed to the anode foil 3 of the lead terminal 6-1 or the entire s urface of the lead terminal 6-1. The method of forming the coating layer 14 may be for med by applying or spraying a coating agent to the part intended for coating layer 14 for mation, and if the coating layer 14 is formed on the entire surface of the drawing termin als 6-1, the drawing terminals 6-1 may be immersed in the coating agent. In the case of f orming the coating layer 14 on the surface of the anode foil 3, of the portion in contact with the lead terminal 6-1 of the anode foil 3 may be formed between the end of the con necting portion 15-1 and the lead terminal lead-out end face 11 of the lead terminal 6-1 and the anode foil 3 may be formed on the surface in contact with the lead terminal 6-1. The coating agent may elasticate the conductive polymer forming solution and, more pa rticularly, elasticity of the solvent of the solution. Examples thereof include resins of flu orine system such as polytetrafluoroethylene (PTFE), perfluoroalkoxy alkanes (PFA), p erfluoroethylene propene copolymer (FEP), ethylene tetrafluoroethylene copolymer (ET FE), and polyvinylidene fluoride (PVDF), and silicone-based resins such as linear dimet hylpolysiloxane (terminal trimethylsilyl group), cyclic dimethylpolysiloxane, linear dial kylpolysiloxane, reticulated methyl-phenyl-polysiloxane, reticulated methyl methoxy · polysiloxane, and methyl-hydrodiene-polysiloxane These resins may be used alone or in combination. Note that, as the mixed one, a perfluoropoly ethers group and a perfluoro poly having an alkoxysilyl group in a molecule. Examples thereof include a group-modif ied silane and the like. The coating layer formation step may include forming the coatin g layer 14 followed by removing the coating layer 14 of the intended connection with th e drawer terminals 6-1. For example, of the coating layer 14 may be peeled off the conn ection scheduled portion between the lead terminal 6-1 by laser irradiation.

In the wrapping process, defects such as voids, fissures, or scratches have oc curred at each site of the dielectric oxide capsule due to insufficient formation of the die lectric oxidation capsule or bending stress caused by turning. Therefore, in the restorativ e treatment, the capacitor element 2 is immersed in the liquor. As the chemical conversi on solution of the remediation chemical conversion, a phosphoric acid system such as a mmonium dihydrogen phosphate or diammonium hydrogen phosphate, a Boric Acid sys tem such as ammonium borate, or an aqueous solution obtained by dissolving an adipic acid system such as ammonium adipate in water is used. Immersion time, 5 minutes or more 120 minutes or less is desirable. Thereafter, in order to remove the chemical conve rsion liquid from the capacitor element 2, the capacitor element 2 immersed in the chem ical conversion liquid with a chemical conversion liquid cleaning liquid such as pure wa ter is washed.

Furthermore, in the winding step, physical contact has occurred in the lead t erminal 6-1 and the dielectric oxide film by winding. This contact, of the anode foil 3, a large defect portion such as cracks and scratches in the range in contact with the lead ter minal 6-1 has occurred. In particular, the region in contact with the corner of the flat pla te portion 7 of the lead terminal 6-1, the defect portion is most likely to occur.

The defect caused by the presence of these external leading terminals 6-1 is not completely repaired by the restoration process. Accordingly, the defect generated by the presence of the external leading terminals 6-1 remains after the restoration process.

After the restorative chemical conversion step, the chemical conversion solu tion and the chemical conversion solution cleaning solution are removed by drying. In t his drying process, the capacitor element 2 is exposed to a hyperthermic environment of at least 100° C. for not more than 30 minutes. In addition to drying by heat, the solvent may be volatilized by vacuum drying.

After drying the capacitor element 2, it forms a solid electrolyte. In the elect rolyte forming step, first, a dispersion liquid in which a conductive polymer is dispersed is prepared. This dispersion is an example of a solution forming a conductive polymer. The conductive polymer is a doped conjugated polymer. As the conjugated polymer, a k nown one can be used without any particular limitation. Examples thereof include polyp yrrole, polythiophene, polyfuran, polyaniline, polyacetylene, polyphenylene, polypheny lene vinylene, polyacene, and polythiophene vinylene. These conjugated polymers may be used alone, or 2 or more kinds thereof may be combined, and may be further a copol ymer of 2 or more kinds of monomers.

Among the above conjugated polymers, a conjugated polymer composed of thiophene or a derivative thereof polymerized is preferred, and a conjugated polymer in which a 3,4-ethylenedioxythiophene (i.e., 2,3-dihydrothieno[3,4-b][1,4]dioxin), a 3-alky lthiophene, a 3-alkoxythiophene, a 3-alkyl-4-alkoxythiophene, a 3,4-alkylthiophene, a 3,4-alkoxythiophene, or a derivative thereof is polymerized is preferred.

As the thiophene derivative, a compound selected from thiophene having a s ubstituent at the 3 and 4 positions is preferred, and the substituent at the 3 and 4 position s of the thiophene ring may form a ring together with the carbon at the 3 and 4 position s. Although 1 to 16 carbon atoms are suitable for alkyl or alkoxy groups, particularly pr eferred are polymers of 3,4-ethylenedioxythiophene, designated EDOT, i.e., poly(3,4-et hylenedioxythiophene), designated PEDOT. Also, alkylated ethylenedioxythiophene ha ving an alkyl group added to a 3,4-ethylenedioxythiophene, and examples thereof includ e methylated ethylenedioxythiophene (i.e., 2-methyl-2,3-dihydro-thieno[3,4-b] [1,4]d ioxin), ethyl ethylenedioxythiophene (i.e., 2-ethyl-2,3-dihydro-thieno[3,4-b] [1,4]dio xin), and the like.

As the dopant, a known one can be used without any particular limitation. E xamples include inorganic acids such as boric acid, nitric acid, acetic acid, oxalic acid, c itric acid, ascotic acid, tartaric acid, squaric acid, rhodizonic acid, chloroconic acid, salic ylic acid, p-toluenesulfonic acid, 1,2-dihydroxy-3,5-benzenedisulfonic acid, methanesul fonic acid, trifluoromethanesulfonic acid, borodisalicylic acid, bisoxalate borate acid, su lfonylimidic acid, dodecylbenzenesulfonic acid, propylnaphthalenesulfonic acid, butyln aphthalenesulfonic acid, and other organic acids. Further, examples of the polyanion inc lude polyvinyl sulfonic acid, polystyrene sulfonic acid, polyallyl sulfonic acid, polyacry lic sulfonic acid, polymethacrylic sulfonic acid, poly(2-acrylic amides-2-methylpropane sulfonic acid), polyisoprene sulfonic acid, polyacrylic acid, polymethacrylic acid, and p olymaleic acid.

These dopants may be used alone, or 2 or more of them may be used in com bination. Further, these dopants may be a polymer of a single monomer, and may be a c opolymer of 2 or more kinds of monomers. In addition, a polymer or a monomer may b e used as the dopant.

By way of example, the conductive polymer is preferably a mixture of a po wder of PEDOT and a solid content of a dopant composed of polystyrene sulfonic acid. In addition, in order to improve the impregnation property and conductivity of the dispe rsion of the conductive polymer, various additives may be added to the conductive poly mer, or neutralization by addition of cations may be performed.

The solvent of the dispersion may be any solvent in which particles or powd ers of the conductive polymer are dispersed, and for example, water, an organic solvent, or a mixture thereof is used. Examples of the organic solvent include polar solvents, alc ohols, esters, hydrocarbons, carbonate compounds, ethers compounds, chain-like ethers, heterocyclic compounds, and nitrile compounds.

Examples of the polar solvents include N-methyl-2-pyrrolidone, N,N-dimet hylform amides, N,N-dimethylaceto amides, and dimethyl sulfoxide. Examples of the al cohols include methanol, ethanol, propanol, and butanol. Examples of esters include eth yl acetate, propyl acetate, and butyl acetate. Hydrocarbons Examples thereof include he xane, heptane, benzene, toluene, and xylene. Examples of the carbonate compound inclu de ethylene carbonate and propylene carbonate. Ethers Examples of the compound inclu de dioxane and di ethyl ethers Chain ethers Examples thereof include ethylene glycol di alkyl ethers, Propylene Glycol dialkyl ethers, polyethylene glycol dialkyl ethers, and pol ypropylene glycol dialkyl ethers Examples of the heterocyclic compound include 3-met hyl-2-oxazolidinone and the like. Examples of the nitrile compound include acetonitrile, glutalodinitrile, methoxy acetonitrile, propionitrile, and benzonitrile.

As a solvent of the dispersion, ethylene glycol is suitable. Ethylene glycol is one of solvents of an electrolytic solution to be described later, and does not become an impurity even if it remains in the capacitor element 2, and further, among the electric c haracteristics of the product, a ESR can be particularly reduced.

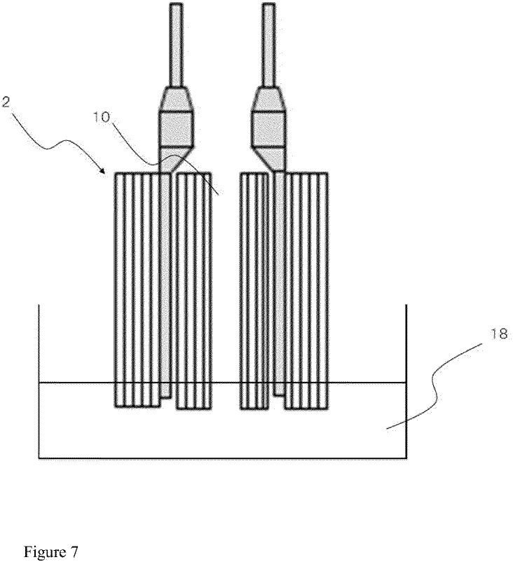

FIG. 7 is a schematic view showing a state in which the dispersion liquid 18 of the conductive polymer is impregnated into the wound body. As shown in FIG. 7, after preparing the dispersion solution 18, the end face opposite to the withdrawal end fa ce 11 of the capacitor element 2 is immersed in this dispersion solution 18. Dispersion li quid 18 creeps up to the opening of the lead terminal lead-out end face 11 side from the opening opposite to the lead terminal lead-out end face 11 of the capacitor element 2 of the hole portion 10. The dispersion liquid 18 creeping up to the lead terminal lead-out e nd face 11 of the capacitor element 2 and the dispersion liquid 18 immersed in the oppo site end face of the lead-out terminal lead-out end face 11, the conductive polymer is spr ead by the dispersion liquid 18 penetrates toward the center portion of the capacitor ele ment 2. At this time, between the lead-out terminal deriving end face 11 side and the an ode foil 3 of the capacitor element 2 of the flat plate portion 7 of the lead terminal 6-1, t he stress at the time of connection between the restoring force and the anode foil 3 and t he lead-out terminal 6-1 of the anode foil 3 voids 13-1, 13-2 occur. For the gap portion 13-2 of the end surface side opposite to the lead terminal lead-out end face 11 of the cap acitor element 2, since the upper is closed, the dispersion liquid 18 is hardly enters. On t he other hand, with respect to the gap portion 13-1 of the lead-out terminal lead-out end face 11 side, since the upper portion of the gap portion 13-1 is open, the dispersion liqui d 18 has a structure that easily penetrates. However, as in the present embodiments, at le ast the coating layer 14 is formed in the vicinity of the entry site, making dispersion 18 difficult to penetrate. Therefore, conductive polymers are difficult to adhere near the def ect caused by the presence of the external leading terminals 6-1. On the other hand, exce pt around the gap portions 13-1 and 13-2, the conductive polymer is spread to the capaci tor element 2.

The impregnation time can be set accordingly according to the size of the ca pacitor element 2. Prolonged impregnation has no adverse effect on properties. When i mpregnated into a capacitor element 2, decompression or pressurization may be used as needed to facilitate impregnation. The impregnation step may be repeated multiple time s. The solvent of the dispersion of the conductive polymer is removed by transpiration b y drying if necessary. Heating and drying or drying under reduced pressure may be perf ormed if necessary.

In this electrolyte forming step, a dispersion solution of a conductive polym er is used for forming a solid electrolyte, but a solid electrolyte may be formed using a c onductive polymer solution in which a conductive polymer is dissolved, for example, a soluble conductive polymer solution. Since the former is a dispersion, it is different in t hat a conductive polymer is dissolved in a solution and dispersed, whereas in the latter s oluble conductive polymer solution, a conductive polymer is dissolved in a solution. By any treatment, a solid electrolyte may be formed in the capacitor element 2, and the pres ent invention is not limited to these methods.

In addition, as described above, a dispersion solution of a conductive polym er or a soluble conductive polymer solution may be used for forming a solid electrolyte, but is not limited thereto. For example, a solution containing a precursor of a conductive polymer may be immersed in the capacitor element 2, and then a solid electrolyte by ch emical polymerization or a solid electrolyte by electrolytic polymerization may be form ed. A conductive polymer layer by chemical polymerization forms a solid electrolyte b y, for example, using a 3,4-ethylenedioxythiophene as a polymerizable monomer and an alcohol solution of ferric paratoluenesulfonate as an oxidizing agent (such as ethanol), i mmersing a capacitor element in a mixed liquid of the above polymerizable monomer a nd an oxidizing agent, and generating a polymerization reaction of the conductive poly mer by heating. In addition, a water washing treatment may be performed in which unre acted monomers or excess monomers are removed by washing with water before and aft er the heat treatment. Solid electrolyte by electrolytic polymerization forms a solid elect rolyte on the surface of a self-doped conductive polymer layer by electrolytic polymeriz ation. This self-doped conductive polymer layer is fed from the feeding electrode as an electrode to form a solid electrolyte. As this electrolytic polymerization solution, a mon omer having conductivity can be used by electrolytic polymerization. As the monomer, a thiophene monomer or a pyrrole monomer is suitable. When these monomers are use d, the capacitor element is impregnated in a stainless steel container into an aqueous sol ution for electrolytic polymerization containing a monomer and sodium 1-naphthalenes ulfonate as a supporting electrolyte, and a predetermined voltage is applied. Thus, a soli d electrolyte made of a water-soluble monomer (e.g., thiophene, pyrrole, or the like) by electrolytic polymerization can be uniformly formed.

When an electrolytic solution is used in combination as an electrolyte, a soli d electrolyte is formed, and then an electrolytic solution is impregnated into the capacito r element 2 The electrolytic solution is filled in a void of a capacitor element 2 in which a solid electrolyte is formed. The electrolytic solution may be impregnated to such an ex tent that the solid electrolyte swells. In the step of impregnating the electrolytic solution, a decompression treatment or a pressure treatment may be performed if necessary.

Examples of the solvent of the electrolytic solution include a protic organic polar solvent or an aprotic organic polar solvent, and may be used alone or in combinati on of 2 or more. Further, as a solute of the electrolytic solution, anionic component or c ationic component is included. The solute is typically a salt of an organic acid, a salt of an inorganic acid, or a salt of a complex compound of an organic acid and an inorganic acid, and is used alone or in combination of 2 or more. An acid serving as an anion and a base serving as a cation may be separately added to the solvent.

Examples of the protic organic polar solvent which is a solvent include mon ohydric alcohols, polyhydric alcohols, and oxyalcohol compounds. Examples of the mo nohydric alcohols include ethanol, propanol, butanol, pentanol, hexanol, cyclobutanol, c yclopentanol, cyclohexanol, and benzyl alcohol. Examples of the polyhydric alcohol an d the oxyalcohol compound include ethylene glycol, Propylene Glycol, Glycerin, methy lcellosolve, ethyl cellosolve, methoxy Propylene Glycol, di methoxy propanol, and alky lene oxide adducts of polyhydric alcohols such as polyethylene glycol and polyoxyethyl ene glycerin. Among them, ethylene glycol is preferred as the solvent. Ethylene glycol 1 eads to changes in the conformation of conductive polymers with good early ESR prope rties and even better high temperature properties. The ethylene glycol may be more than 50 wt% in the fluid.

Examples of the aprotic organic polar solvent which is a solvent include a su lfone system, a amides system, a lactone, a cyclic amides system, a nitrile system, and a n oxide system. Examples of the sulfone system include dimethylsulfone, ethyl methyls ulfone, di ethyl sulfone, sulfolane, 3-methylsulfolane, and 2,4-dimethylsulfolane. Exam ples of amides system include N-methylform amides, N,N-dimethylform amides, N-eth yl form amides, N,N-di ethyl form amides, N-methylaceto amides, N,N-dimethylaceto a mides, N-ethyl aceto amides, N,N-di ethyl aceto amides, and hexamethylphosphoric am ides. Lactones, cyclic amides Examples of the system include γ-butyrolactone, γ-valerol actone, δ-valerolactone, N-methyl-2-pyrrolidone, ethylene carbonate, propylene carbona te, butylene carbonate, and isobutylene carbonate. Examples of the nitrile system includ e acetonitrile, 3-methoxy propionitrile, and glutaronitrile. Examples of the oxide system include dimethyl sulfoxide and the like.

As organic acids to be anionic component, carboxylic acids such as oxalic a cid, succinic acid, pimelic acid, sebacic acid, phthalic acid, isophthalic acid, terephthalic acid, adipic acid, benzoic acid, toluic acid, malonic acid, 1,6-decandicarboxylic acid, az elaic acid, phloroglucinic acid, gentisic acid, protocatechuic acid, trimellitic acid, pyrom eric acid, etc.,Sulfonic acid is included. Further, examples of the inorganic acid include Boric Acid, phosphoric acid, phosphorous acid, hypophosphorous acid, carbonic acid, a nd silicic acid. Compounds of organic acids and inorganic acids include borodisalicylic acid, borodicholic acid, borodimalonic acid, borodiborozic acid, borodiazelaic acid, bor odibenzoic acid, borodimaleic acid, borodimaleic acid, borodimalic acid, boroditaric aci d, borodicitric acid, borodiphthalic acid, borodiresorcinic acid, borodimethylsalicylic aci d, borodinaphthoic acid, borodimandelic acid and borodi(3-hydroxy)propionic acid, etc.

Further, examples of the salt of at least 1 of the organic acid, the inorganic a cid, and the composite compound of the organic acid and the inorganic acid include an a mmonium salt, a quaternary ammonium salt, a quaternary amidinium salt, an amine salt, a sodium salt, and a potassium salt. Examples of the quaternary ammonium ion of the q uaternary ammonium salt include tetramethylammonium, tri ethyl methylammonium, a nd tetra ethyl ammonium. Quaternary amidinium salts include ethyl dimethylimidazolin ium, tetramethylimidazolinium, and the like. Examples of the amine salt include salts of primary amines, secondary amines, and tertiary amines. Examples of the primary amine include methylamine, ethyl amine, propylamine, and the like, and examples of the seco ndary amine include dimethylamine, di ethyl amine, ethyl methylamine, and dibutylami ne, and examples of the tertiary amine include trimethylamine, tri ethyl amine, tributyla mine, ethyl dimethylamine, and ethyl diisopropylamine.

Further, other additives may be added to the electrolytic solution. Examples of excipients include alkylene-oxide adducts of polyhydric alcohols such as poly-or pol y-yleneglycerin, complexes of boric and polymorphic alcohols (mannito, solbit, etc.), co mplexes of boric and polyhydric alcohols, boric esters, nitro compound (o-nitrobenzoic m-, nitrobenzoic p-, nitrobenzoic o-, nitro phenolic, m-nitro phenolic, p-nitro phenolic, a nd p-nitrobenzil alcohols, and so on), and esters Phosphate. These may be used alone, a nd 2 or more of them may be used in combination. The amount of the additive to be add ed is not particularly limited, but is preferably added to an extent that does not deteriorat e the characteristics of the solid electrolytic capacitor 1, and is, for example, 60 wt% or l ess in a liquid.

Capacitor element 2 with a solid electrolyte formed is housed in a bottomed cylindrical outer case 16 and sealed with an inclusion body 17 consisting of an elastic m ember such as rubber. Materials of the outer case 16 include aluminum resin containing aluminum, manganese, etc. or stainless steel. The external leading terminals 6-1 and 6-2 are drawn from the inclusion body 17. The entire circumference of the opening side end portion of the outer case 16 is caulked, the manufacture of the solid electrolytic capacit or 1 is completed.

Still, in this solid electrolytic capacitor 1, a thin 1 to 10V oxidized capsule may be formed by metaplasticization treatment as needed in the superficial layer of cath odal foil 4.

The separator 5 electrically isolates anodal foil 3 and cathodal foil 4 to preve nt shunting and retains a solid electrolyte, or a solid electrolyte, and an electrolyte. Whe n solid electrolyte retention is high and shape can be retained without a separator, the se parator may be eliminated.

### Effect

When conductive polymer is present in the vicinity of the defect portion, the leakage current of the solid electrolytic capacitor 1 is increased. On the other hand, whe n there is no conductive polymer in the vicinity of the defective portion, the leakage curr ent of the solid electrolytic capacitor 1 is suppressed. Even if the electrolyte is present n ear the defect, the leakage current converges when there is no conductive polymer. Furt hermore, even if the conductive polymer is present in the vicinity of the defective portio n, when there is also an electrolyte in the vicinity of the defective portion, the leakage c urrent converges.

The stress at the time of connection between the anode foil 3 and the drawin g terminal 6-1, and the gap portion 13-1 between the anode foil 3 and the drawing termi nal 6-1 caused by the action exerted on the outer peripheral side of the capacitor elemen t 2 by the restoring force having the anode foil 3, the dispersion liquid 18 of the conduct ive polymer enters. Dielectric oxide film present in the gap portion 13-1, by contact wit h the extraction terminal 6-1, since there is a large defect portion, by the conductive pol ymer is adhered thereto, the leakage current is likely to increase. Moreover, even in the presence of electrolyte solution as an electrolyte, the size of the opening of the void 13-1 is slight, so when the conductive polymer is attached, the electrolyte cannot enter the i nterior of the void 13-1, making the leakage current difficult to converge.

In the solid electrolytic capacitor 1, since the coating layer 14 is formed at le ast in a portion facing the anode foil 3 of the lead terminal 6-1, the dispersion liquid 18 of the conductive polymer which tries to penetrate into the gap portion 13-1 which is for med between the anode foil 3 and the lead terminal 6-1, at least the void portion 13-1 It is suppressed from entering. Therefore, in the vicinity of the defect portion generated by the presence of the lead terminal 6-1, the conductive polymer is less than the other porti ons of the capacitor element 2.

Therefore, the leakage current of the solid electrolytic capacitor 1 is suppres sed, or the leakage current of the solid electrolytic capacitor 1 converges.

Thus, it may be possible to elastize an conductive polymer-forming solution that attempts to enter the void 13-1 between anodal foil 3 and external leading terminal s 6-1, and to form a coating layer 14 on the surface of anodal foil 3.

### EXAMPLE

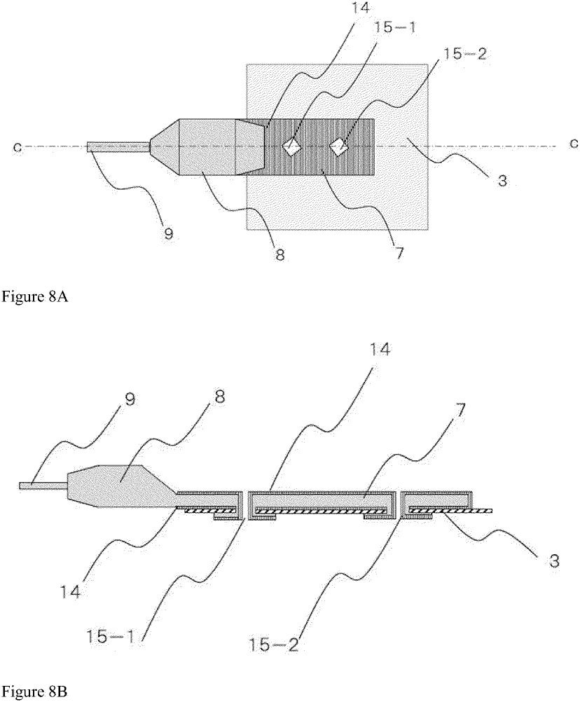

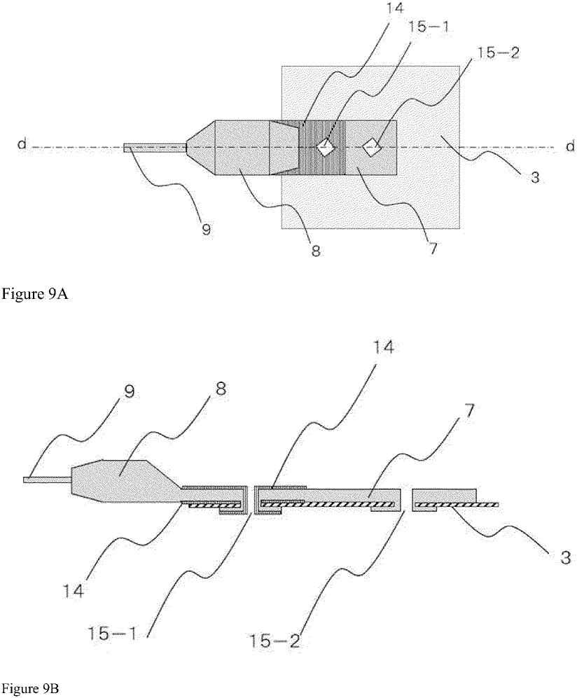

The solid electrolytic capacitors of the invention are described in detail belo w with reference to FIGS. 8 and 9. FIG. 8 is a diagram showing a formation position of the coating layer 14 of Example 1, FIG. 8A, the drawing from the plane direction of t he anode foil 3 connecting the lead terminal 6-1, FIG. 8B is a c-c cross-sectional view of FIG. 8A. 9 is a diagram showing a formation position of the coating layer 14 of Exampl e 2, FIG. 9A, the drawing from the plane direction of the anode foil 3 connecting the lea d terminal 6-1, FIG. 9B is a d-d cross-sectional view of FIG. 9A. Note that the present in vention is not limited to the following examples.

### Example 1

As follows, solid-state electrolytic capacitor 1 of example 1 was created. An ode foil 3 and the cathode foil 4 is a strip-shaped aluminum foil which is elongated. Ano de foil 3 is widened by etching treatment, to form a dielectric oxide film by chemical co nversion treatment. Cathode foil 4 was plain foil or etched untreated.

As shown in FIGS. 8A and B, the plate 7 of the drawer terminals 6-1 was i mmersed in a solution of the coating agent to form the coating layer 14 in all 7 planes of the drawer terminals 6-1. The thickness of coating layer 14 served as 200 nm. As the co ating liquid, an fluorine type resin containing an organic solvent obtained by mixing m-xylene hexafluoride, ethyl perfluoroisobutyl ethers, and ethyl perfluorobutyl ethers was used as an organic solvent.

The anode foil 3 was attached by stitch connection lead terminal 6-1 to form a coating layer 14. The flat plate portion 7 of the lead terminal 6-1 along one surface of the anode foil 3 so as to be perpendicular to the long side of the anode foil 3, the round bar portion 8 is along so as to protrude from one long side of the anode foil 3. The catho de foil 4 also connected the extraction terminal 6-2 in the same manner. These anode foi l 3 and the cathode foil 4 is opposed via a separator 5 of the manila system, wound so th at the long side is rounded, to form a capacitor element 2.

Capacitor element 2 was immersed in an aqueous solution of ammonium dih ydrogen phosphate at 90° C. for 20 minutes, and the current of 5 mA was electrified for 5 6.5V of applied voltages during the immersion time. After completion of the repair che mical conversion, the capacitor element 2 was left standing for 30 minutes under a temp erature environment of 105° C., and dried.

After the capacitor element 2 was dried, it was immersed in an aqueous solu tion in which polystyrene sulfonic acid (PSS) and polyethylenedioxythiophene (PEDO T) were dispersed in water in a reduced pressure environment of 30 kPa for 120 seconds from the side opposite to the lead-out terminal leading end surface 11 of the capacitor el ement 2 Thereafter, it was left standing for 30 minutes under a temperature environment of 150° C., and the capacitor element 2 was dried. Immersion and drying were used as a series of treatments, and the series of treatments was repeated twice. This led to the for mation of a solid electrolyte in the capacitor element 2.

Next, an electrolytic solution obtained by adding ammonium borodisalicylat e to a 5% ethylene glycol solution was prepared, and an electrolytic solution was impreg nated into the capacitor element 2 in which a solid electrolyte was formed. Thereby the prepared φ6.1 mm and the height 6.3 mm of the winding capacitor element 2 is inserted i nto the bottomed cylindrical aluminum outer case 16, by mounting the sealing body 17 t o the open end, sealed by crimping. Then, subjected to voltage application for 45 minute s under a temperature environment of 115° C., it was subjected to aging treatment for t he solid electrolytic capacitor 1.

### Example 2

As follows, a solid-state electrolytic capacitor of example 2 was fabricated. 9A, as shown in B, the coating layer 14 is formed only on the metal line 9 side of the fla t plate portion 7 of the lead terminal 6-1. Specifically, the portion forming the coating la yer 14, of the portion in contact with the anode foil 3 of the lead terminal 6-1, the conne cting portion 15-1 closest to the metal line 9 of the connecting portion 15 of the anode f oil 3 and the lead terminal 6-1, the flat plate portion 7 It corresponds to the formation po sition to the end of the side of the metal line 9. Others were created with the same metho d and the same conditions as solid electrolytic capacitor 1 in Example 1.

### Comparative Example 1

A solid-state electrolytic capacitor for comparison example 1 was created as follows: Except for not forming a coating layer in the external leading terminal, it was prepared under the same method and the same conditions as the solid electrolytic capaci tor 1 of Example 1.

### Leakage Current Test

The solid electrolytic capacitors of Example 1, Example 2 and Comparative Example 1 were prepared in 60 pieces, and the reflow step with 260° C. as the peak temp erature was repeated twice for each solid electrolytic capacitor, and the leakage current was measured. The leakage current was measured for 120 seconds from the beginning o f application with the application of a 35 V at a temperature of 20° C.

The average values of the measured results of leakage currents of the solid e lectrolyte capacitors of Example 1, Example 2 and Comparative Example 1 are shown i n Table 1 below.

TABLE 1

Leakage Current

| | Initial [µ A] | After Test [µ A] |
|---|---|---|
| Example 1 | 0.5 | 0.6 |
| Example 2 | 0.4 | 0.7 |
| Comparative Example 1 | 0.5 | 10.5 |

As can be seen in Table 1, the solid-state electrolyte capacitor of Comparati ve Example 1 showed increased leakage currents after the test. On the other hand, solid electrolytic capacitor 1 of example 1 and example 2, which formed coating layer 14, did not show elevated leakage currents even after testing. Further, the coating layer 14, of t he portion in contact with the anode foil 3 of the lead terminal 6-1, of the connecting po rtion 15 between the anode foil 3 and the lead terminal 6-1, the connection portion 15-1 closest to the metal wire 9, the flat plate portion 7 it was recognized that there is an effe ct if formed at a position corresponding to the end of the metal line 9 side.

### Example 3

As follows, solid-state electrolytic capacitor 1 of example 3 was fabricated. The thickness of coating layer 14 formed in the drawer terminals 6-1 served as 100 nm. Others were created with the same method and the same conditions as solid electrolytic capacitor 1 in Example 1.

### Example 4

As follows, solid-state electrolytic capacitor 1 of example 4 was fabricated. The thickness of coating layer 14 formed in the drawer terminals 6-1 served as 50 nm. O thers were created with the same method and the same conditions as solid electrolytic ca pacitor 1 in Example 1.

### Example 5

As follows, solid-state electrolytic capacitor 1 of example 5 was fabricated. The thickness of coating layer 14 formed in the drawer terminals 6-1 served as 40 nm. O thers were created with the same method and the same conditions as solid electrolytic ca pacitor 1 in Example 1.

### Example 6

As follows, solid-state electrolytic capacitor 1 of example 6 was fabricated. The thickness of the coating layer 14 formed on the extraction terminal 6-1 was a 30 nm.

Others were created with the same method and the same conditions as solid electrolytic capacitor 1 in Example 1.

### Example 7

As follows, solid-state electrolytic capacitor 1 of example 7 was fabricated. The thickness of coating layer 14 formed in the drawer terminals 6-1 served as 20 nm. O thers were created with the same method and the same conditions as solid electrolytic ca pacitor 1 in Example 1.

### Example 8

As follows, solid-state electrolytic capacitor 1 of example 8 was fabricated. The thickness of the coating layer 14 formed on the extraction terminal 6-1 was a 10n.

Others were created with the same method and the same conditions as solid electrolytic capacitor 1 in Example 1.

### Example 9

As follows, solid-state electrolytic capacitor 1 of example 9 was fabricated. The thickness of coating layer 14 formed in the drawer terminals 6-1 served as 5.2 nm. Others were created with the same method and the same conditions as solid electrolytic capacitor 1 in Example 1.

### Example 10

As follows, solid-state electrolytic capacitor 1 of example 10 was fabricated. The thickness of coating layer 14 formed in the drawer terminals 6-1 served as 1.5 nm. Others were created with the same method and the same conditions as solid electrolytic capacitor 1 in Example 1.

### Leakage Current Test 2

Leakage currents of solid electrolytic capacitors of Example 1, Examples 3 t o 10 and Comparative Example 1 were measured. The measurement conditions for leak age current are the same conditions as for leakage current test 1 performed in example 1, example 2, and comparison example 1.

### Wettability Test

In addition, wettability of the coating layer of Example 1, Example 3 to Exa mple 10 with the dispersion liquid for each film thickness was confirmed. The wettabilit y is determined by measuring the contact angle of the coating agent used in each of the examples and comparative examples. Specifically, a coating layer of membrane thickne ss set in Example 1, Examples 3-10 was formed on the surface of aluminum foil in a pla ne that has not been subjected to such treatments as diffusion surface treatment such as etching treatment or dielectric oxide capsule formation treatment. Next, the dispersion li quid used in Example 1, Examples 3 to 10 and Comparative Example 1 described above was dropped into an aluminum foil having a coating layer formed thereon and an alumi num foil having no coating layer corresponding to Comparative Example 1, and the con tact angle between the dispersion liquid and the aluminum foil after 20 seconds was det ermined by a Young-Lapace method.

The contact angle of each thickness of the coating layer set in Example 1, E xamples 3 to 10 and Comparative Example 1, and the average value of the measurement results of leakage currents of the solid electrolyte capacitor in Examples 1, Examples 3 to 10 and Comparative Example 1 are shown in Table 2 below.

TABLE 2

| | Thickness of Coating Layer [nm] | Contact Angle [degree] | Leakage Current | | |
|---|---|---|---|---|---|
| | | | initial | After Test | Rate of Change |
| | | | [µA]:A | [µA]:B | [B*100/A][%\| |
| Example 1 | 200 | 84 | 0.5 | 0.7 | 140 |
| Example 3 | 100 | 84 | 0.5 | 0.7 | 140 |
| Example 4 | 50 | 83 | 0.5 | 0.7 | 140 |
| Example 5 | 40 | 83 | 0.6 | 0.9 | 150 |
| Example 6 | 30 | 82 | 0.6 | 0.9 | 150 |
| Example 7 | 20 | 82 | 0.6 | 0.9 | 150 |
| Example 8 | 10 | 83 | 0.5 | 0.9 | 180 |
| Example 9 | 5.2 | 73 | 0.5 | 9.6 | 1920 |
| Example 10 | 1.5 | 66 | 0.6 | 8.1 | 1353 |
| Comparative Example 1 | - | 53 | 0.5 | 10.5 | 2100 |

As can be seen in Table 2, Examples 1 and 3-10, which formed coating laye r 14, had smaller leakage currents and smaller rates of change after testing compared wit h Example 1, which did not form coating layer 14. This shows that forming the coating layer 14 is effective in reducing the leakage current. Also, examples 1 and examples 3-8, in which the membrane thickness of coating layer 14 is taken as 10 nm or greater, have a substantially reduced rate of change compared to examples 9 and 10, in which coating layer 14 is 10 nm or less. In addition, examples 1 and examples 3-7, in which the membr ane thickness of coating layer 14 was 20 nm or greater, showed leakage currents that fell within 150% before and after the test, confirming the remarkable efficacy. Further, whe n checked by matching the contact angle of the coating layer 14, it was confirmed to be related to the reduction of the leakage current. That is, by the contact angle is 80 ° or mo re of the coating layer 14, the leakage current was confirmed to converge to a minimum in the solid electrolytic capacitor 1.

Next, in order to confirm the influence of connectivity with the anode foil 3 by the coating layer 14, the contact resistance was measured.

### Example 11

As follows, a solid-state electrolytic capacitor of example 11 was fabricated. Specifically, the thickness of the coating layer 14 formed in the drawer terminals 6-1 w as used as 200 nm, and the others were prepared in the same method and the same condit ions as the solid electrolyte capacitor 1 in Example 1.

### Example 12

As follows, a solid-state electrolytic capacitor of example 12 was fabricated. Except for 150 nm of the thickness of the coating layer 14 formed in the external leadin g terminals 6-1, it was prepared in the same method and the same conditions as the solid electrolyte capacitor 1 in Example 1.

### Example 13

As follows, a solid-state electrolytic capacitor of example 13 was fabricated. Except for 100 nm of the thickness of the coating layer 14 formed in the external leadin g terminals 6-1, it was prepared in the same method and the same conditions as the solid electrolyte capacitor 1 in Example 1.

### Example 14

As follows, a solid-state electrolytic capacitor of example 14 was fabricated. Except for 80 nm of the thickness of the coating layer 14 formed in the external leading terminals 6-1, it was prepared in the same method and the same conditions as the solid e lectrolyte capacitor 1 in Example 1.

### Example 15

As follows, a solid-state electrolytic capacitor of example 15 was fabricated. Except for 60 nm of the thickness of the coating layer 14 formed in the external leading terminals 6-1, it was prepared in the same method and the same conditions as the solid e lectrolyte capacitor 1 in Example 1.

### Example 16

As follows, a solid-state electrolytic capacitor of example 16 was fabricated. Except for 50 nm of the thickness of the coating layer 14 formed in the external leading terminals 6-1, it was prepared in the same method and the same conditions as the solid e lectrolyte capacitor 1 in Example 1.

### Example 17

As follows, a solid-state electrolytic capacitor of example 17 was fabricated. Except for 40 nm of the thickness of the coating layer 14 formed in the external leading terminals 6-1, it was prepared in the same method and the same conditions as the solid e lectrolyte capacitor 1 in Example 1.

### Example 18

As follows, a solid-state electrolytic capacitor of example 18 was fabricated. Except for 30 nm of the thickness of the coating layer 14 formed in the external leading terminals 6-1, it was prepared in the same method and the same conditions as the solid e lectrolyte capacitor 1 in Example 1.

### Example 19

As follows, a solid-state electrolytic capacitor of example 19 was fabricated. Except for 20 nm of the thickness of the coating layer 14 formed in the external leading terminals 6-1, it was prepared in the same method and the same conditions as the solid e lectrolyte capacitor 1 in Example 1.

### Example 20

As follows, a solid-state electrolytic capacitor of example 20 was fabricated. Except for 10 nm of the thickness of the coating layer 14 formed in the external leading terminals 6-1, it was prepared in the same method and the same conditions as the solid e lectrolyte capacitor 1 in Example 1.

### Example 21

As follows, a solid-state electrolytic capacitor of example 21 was fabricated. Except for 5.2 nm of the thickness of the coating layer 14 formed in the external leading terminals 6-1, it was prepared in the same method and the same conditions as the solid electrolyte capacitor 1 in Example 1.

### Example 22

As follows, a solid-state electrolytic capacitor of example 18 was fabricated. Except for 1.5 nm of the thickness of the coating layer 14 formed in the external leading terminals 6-1, it was prepared in the same method and the same conditions as the solid electrolyte capacitor 1 in Example 1.

### Comparative Example 2

As follows, a solid-state electrolytic capacitor for comparison example 2 wa s fabricated. Except for not forming coating layer 14, 6-1 in the external leading termina 1 was created in the same method and the same conditions as solid electrolytic capacitor 1 in example 1.

### Contact Resistance Test

The contact resistance between the anode foil 3 and the extraction terminal 6-1 of Examples 11 to 22 and Comparative Example 2 was measured. Specifically, 10 s olid-state electrolytic capacitors of examples 11-22 and comparison example 2 were cre ated, and for 5 of 10 each, the reflow step with 260° C. as the peak temperature was repea ted twice. Thereafter, decomposing 10 solid electrolytic capacitors, take out the anode f oil 3 lead terminal 6-1 is connected, connecting the respective electrode terminals of the resistor meter to the round bar portion 8 and the anode foil 3 of the lead terminal 6-1. T hen, while maintaining the position of the anode foil 3, by lifting the lead terminal 6-1 0.8 mm, to measure the contact resistance. A model number RM3545 manufactured by Hioki Electric Co., Ltd. was used as the resistive meter. Measurement results show the t otal value of the resistance value and the connection resistance of the lead terminal 6-1 of the anode foil 3. Resistance values of anodal foil 3 and external leading terminals 6-1 are the same values in examples 11 to 22 and comparison example 2 because anodal foi 13 and external leading terminals 6-1 used in each example and comparison example ar e the same values.

The results of this contact resistance test are shown in Table 3 below. Incide ntally, the contact resistance value indicates the average value of five.

TABLE 3

| | Thickness of Coating Layer [nm] | Contact Resistance | | |
|---|---|---|---|---|
| | | initial | After Test | Rate of Change |
| | | [mΩ]:A | [mΩ]:B | [B*100/A][%] |
| Example 11 | 200 | 7.2 | 15.0 | 207.6 |
| Example 12 | 150 | 5.6 | 8.6 | 153.6 |
| Example 13 | 100 | 5.4 | 6.6 | 121.6 |
| Example 14 | 80 | 5.2 | 5.6 | 107.6 |
| Example 15 | 60 | 5.2 | 5.5 | 105.7 |
| Example 16 | 50 | 5.1 | 5.5 | 107.0 |
| Example 17 | 40 | 5.2 | 5.6 | 107.4 |
| Example 18 | 30 | 5.1 | 5.4 | 105.2 |
| Example 19 | 20 | 5.1 | 5.4 | 105.9 |
| Example 20 | 10 | 5.0 | 5.3 | 105.1 |
| Example 21 | 5.2 | 5.1 | 5.2 | 102.0 |
| Example 22 | 1.5 | 5.1 | 5.2 | 102.0 |
| Comparative Example 2 | - | 5.1 | 5.3 | 104.3 |

Since anodal foil 3 and external leading terminals 6-1 of examples 11-22 and comparison example 2 use the same, the resistance value of anodal foil 3 and the res istance value of external leading terminals 6-1 are the same value in examples 11-22 an d comparison example 2. Therefore, the difference in measurement results shown in Tab le 3 is the difference in contact resistance between the anode foil 3 and the extraction ter minal 6-1. As shown in Table 3, Examples 12-22 can reduce the increase in contact resi stance after testing by up to 1.5-fold. From this fact, it is recognized that the increase of the touch resistivity can be suppressed by making the membrane thickness of coating la yer 14 to be less than 150 nm. That is, by the film thickness of the coating layer 14 is eq ual to or less than 150 nm, even if the coating layer 14 is interposed in the connecting po rtion between the anode foil 3 and the extraction terminal 6-1, the anode foil 3 and the e xtraction terminal 6-1 connectivity is maintained, it was confirmed that a low contact re sistance. This is because the coating layer 14 is provided with an insulating property, it i s presumed to be caused by the electrical connectivity between the anode foil 3 and the extraction terminal 6-1 is inhibited. In addition, for Examples 14-22, the increase in con tact resistance after testing can be kept below 1.1-fold. That is to say, it was recognized that the inhibitory effect of the increase of the touch resistance appeared remarkably, wh en the membrane thickness of coating layer 14 was made to be under 80 nm. This is by t he film thickness of the coating layer 14 and 80 nm or less, when connected to the anode foil 3 by pressing the cut and raised pieces during stitch connection, by cut and raised p ieces are elongated, the coating layer 14 formed on the surface of the cut and raised piec es 23 or thinned to the extent that does not affect the connectivity, the ground of the cut and raised pieces 23 is exposed, it is considered that the connectivity with the anode foil is improved.

Thus, it was found that the thickness of coating layer 14 from 80 to 10 nm yi elded a solid electrolytic capacitor 1 with a small leakage current and low resistivity

Explanation of sign

| | |
|---|---|
| 1 | Solid electrolytic capacitor |
| 2 | Capacitor element |
| 3 | Anode foil |
| 4 | Cathode foil |
| 5 | Separator |
| 6–1 | External leading terminal (anodal side) |
| 6–1 | Lead terminal (cathode side) |
| 7 | Flat plate portion |
| 8 | Round bar |
| 9 | Metal wire |
| 10 | Hole |
| 11 | Leading terminal lead-out end face |
| 12 | Hole |
| 13–1, 13–2 | Void portion |
| 14 | Coating layer |
| 15–1, 15–2 | Connecting part |
| 16 | Outer case |
| 17 | Oral inclusion |
| 18 | Dispersion |
| 19 | Inferior type |
| 20 | Perforated portion |
| 21 | Upper type |
| 22 | Stitch needle |
| 23 | Cut piece |
| 24 | Molding die |

What is claimed is:

1-8. (canceled)

9. A Solid Electrolytic Capacitors comprising
an anode foil with dielectric oxide film,
a lead terminal connected to the anode foil,
a capacitor element including the anode foil and
a solid electrolyte formed within the capacitor element and comprising a condu ctive polymer,
wherein a coating layer repealing a conductive polymer forming solution betwe en said anodal foil and an external leading terminal is formed.

10. The Solid Electrolytic Capacitors of claim 9 wherein the coating layer is for med at least at a portion facing the anode foil of the lead-out terminal.

11. The Solid Electrolytic Capacitors of claim 9 wherein the coating layer is for med at least at the lead-out end side of the capacitor element from the connection with the anodal foil of the external leading terminal.

12. The Solid Electrolytic Capacitors of claim 9 wherein the thickness of the coating layer is not less than 10 nm.

13. The Solid Electrolytic Capacitors of claim 9 wherein the contact angle between the surface of the coating layer and the conductive polymer forming solution is 80° or more.

14. The Solid Electrolytic Capacitors of claim 9 wherein the thickness of the coating layer is not claim than 10 nm and not more than 80 nm.

15. The Solid Electrolytic Capacitors of claim 9 wherein the coating layer shall be incompatible with the solution immersed in the restoration process of the capacitor element.

16. Method for manufacturing solid-state electrolytic capacitors, the method com prising,
a winding step of forming a capacitor element by winding the cathode foil and t he anode foil while winding the lead terminal, a winding after connecting the lead termi nal to the anode foil cathode foil and the dielectric oxide film is formed,
an electrolyte formation step that immerses a solution forming a solid electrolyte from the opposite face of the end face of the capacitor element formed around the extern al leading terminal and derived by the external leading terminal connected to the anodal side foil, following the wounding step,
wherein forming a coating layer at least on the anodal external leading terminal.

17. The Solid Electrolytic Capacitors of claim 10 wherein the contact angle betw een the surface of the coating layer and the conductive polymer forming solution is 80° or more.

18. The Solid Electrolytic Capacitors of claim 10 wherein the thickness of the co ating layer is not claim than 10 nm and not more than 80 nm.

19. The Solid Electrolytic Capacitors of claim 10 wherein the coating layer shall be incompatible with the solution immersed in the restoration process of the capacitor el ement.

20. The Solid Electrolytic Capacitors of claim 11 wherein the contact angle betw een the surface of the coating layer and the conductive polymer forming solution is 80° or more.

21. The Solid Electrolytic Capacitors of claim 11 wherein the thickness of the co ating layer is not claim than 10 nm and not more than 80 nm.

22. The Solid Electrolytic Capacitors of claim 11 wherein the coating layer shall be incompatible with the solution immersed in the restoration process of the capacitor el ement.

23. The Solid Electrolytic Capacitors of claim 17 wherein the thickness of the co ating layer is not claim than 10 nm and not more than 80 nm.

24. The Solid Electrolytic Capacitors of claim 17 wherein the coating layer shall be incompatible with the solution immersed in the restoration process of the capacitor element.

25. The Solid Electrolytic Capacitors of claim 23 wherein the coating layer shall be incompatible with the solution immersed in the restoration process of the capacitor element.
